(19) United States
(12) Patent Application Publication
(10) Pub. No.: US 2019/0296618 A1
(43) Pub. Date: Sep. 26, 2019

(54) AUTOMATIC MOTOR LEAD WIRE CUTTING AND TWISTING ASSEMBLY

(71) Applicant: DONGGUAN UNIVERSITY OF TECHNOLOGY, Dongguan (CN)

(72) Inventor: Miao QIANG, Dongguan (CN)

(21) Appl. No.: 16/364,430

(22) Filed: Mar. 26, 2019

(30) Foreign Application Priority Data
Mar. 26, 2018 (CN) CN2018102543602

(51) Int. Cl. H02K 15/00; B21F 11/00; B21F 15/04

(52) U.S. Cl. CPC H02K 15/0087; B21F 15/04; B21F 11/00

(57) ABSTRACT

The present invention relates to an automatic motor lead wire cutting and twisting assembly which may include a rack, a turntable mechanism and a power control box which are both provided on the rack. On the rack surrounding the turntable mechanism are in turn provided a wire collating mechanism, a wire teasing mechanism, a wide cutting mechanism, a single cutting mechanism and a wire twisting mechanism. A wire teasing and securing mechanism is provided on the rack above the wire twisting mechanism. A reject tank is provided on the rack below the wide cutting mechanism and the single cutting mechanism. All of the drive components of the above mechanisms are electrically connected to the power control box. Cooperating with motor production equipment, an automated production line is formed, which mainly comprises turntable mechanism, wire collating mechanism, wire cutting part, and twisting part etc., with delicate structural design, high automation level, and time and human resource saving compared to manual operation, and conduces to improve production efficiency of motor production lines.

### FIELD OF THE INVENTION

The present invention relates generally to the production equipment for motors, and more particularly to an automatic motor lead wire cutting and twisting assembly.

### BACKGROUND OF THE INVENTION

A kind of motor lead wire is needed in the motor production technical field: the lead wire is less than 5 centimeter long and the both ends of the lead wire are covered with a layer of tin. In the prior art, the production of such kind of lead wire is mostly done with manual operation: cut the lead wire into a desired length, twist the lead wire and the twisted end of the wire may be processed by tin immersion. The deficiencies of the prior art may include complex operation, low efficiency and enormous labor due to shortness of the wire and manual operation.

### SUMMARY OF THE INVENTION

The present invention discloses an automatic motor lead wire cutting and twisting assembly. While working with the motor production equipment to form the automated assembly line, the device may include a turntable mechanism, a wire collating part, a line cutting part and a wire twisting part with sophisticate design and high degree of automation. The device may save the time and human labor cost compared with the prior art, which may improve the production efficiency of the motor production assembly line.

To achieve the above purpose, this invention adopts following technology: an automatic motor lead wire cutting and twisting assembly, which comprises a rack, a turntable mechanism and a power control box which are both provided on the rack; a wire collating mechanism, a wire teasing mechanism, a wide cutting mechanism, a single cutting mechanism and a wire twisting mechanism are in turn provided on the rack around the turntable mechanism; a wire twisting and securing mechanism is provided on the rack above the wire twisting mechanism; a reject tank is provided on the rack below the wide cutting mechanism and the single cutting mechanism; all of the drive components of the above mechanisms are electrically connected to the power control box.

Furthermore, the turntable mechanism 5 comprises a servo drive motor 11, a gear box 12, a disk 14, clamping plates 15, a positioning block 16, a central clamp 17 and a wire separation claw 18; the output shaft of the servo drive motor 11 engages with the input shaft of the gear box 12 by a synchronous pulley; the upper end of the output shaft of the gear box 12 is connected to the center of the disk 14; to the outer edge of the disk 14 are evening distributed several clamping plate 15; the central clamp 17 which holds the work piece 13 is provided on the clamping plates 15; a wire separation claw 18 which engages with lead wires of the work piece 13 is provided on the lower part of the central clamp 17; a positioning block 16 cooperating with the work piece 13 is provided on the clamping plates 15; and the servo drive motor 11 is electrically connected to the power control box 1.

Furthermore, the wire collating mechanism may include a spring block, a positioning pin roll, a rotation base, a wire collating base plate, an adjusting board, a pneumatic claw, a wire combing claw, and a first sliding table cylinder; on the wire collating base plate is provided the rotation base and on the rotation base is provided the adjusting board; on the adjusting board is vertically provided the first sliding table cylinder and on the first sliding table cylinder is vertically provided the pneumatic claw; on the upper end of the pneumatic claw is vertically provided the wire combing claw engaging with the work piece; on the wire collating base plate are provided the spring block and the positioning pin roll which engage with each other; the positioning pin roll engages with the positioning hole provided on the side of the rotation base by plugging and fitting; and both the first sliding table cylinder and the pneumatic claw are electrically connected to the power control box.

Furthermore, the wide cutting mechanism may include a left cutting plate, an upper blade, a holding plate, a reject trough, a lower blade, a right cutting plate, a wide cut base plate, a double-end cylinder, and a top plate; on the wide cut base plate is provided the double-end cylinder whose both ends are respectively connected to the left cutting plate and the right cutting plate which engage with each other; both the left cutting plate and the right cutting plate engage slidably with the top plate which is provided on the wide cut base plate; an upper blade is provided on the right end of the left cutting plate and an lower blade which cooperates with the upper blade is provided on the left end of the right cutting plate; an holding plate which joins and cooperates with the right cutting plate is provided on the left cutting plate; above the top plate below the holding plate is provided the reject trough and the double-end cylinder is electrically connected to the power control box.

Furthermore, the wire teasing mechanism may include a wire teasing rack, a wire teasing pin, a wire teasing pin pushing cylinder, a wire teasing pin translation cylinder, a wire teasing lifting seat, a wire teasing lifting cylinder, and an upper connecting plate; the wire teasing lifting cylinder is vertically provided on the wire teasing rack by the upper connecting plate and the output end of the wire teasing lifting cylinder is connected to the wire teasing lifting seat; the bottom of the wire teasing lifting seat is connected to the wire teasing pin translational cylinder, whose output end is connected to the wire teasing pin push cylinder; the output end of the wire teasing pin push cylinder is connected to the wire teasing pin engaging with the work piece and all the wire teasing lifting cylinder, the wire teasing pin translational cylinder and the wire teasing pin push cylinder are electrically connected to the power control box.

Furthermore, the single cutting mechanism may include a single cut base plate, a second sliding table cylinder, a pneumatic scissors, a pneumatic collet, an adjusting handle, a scissors lifting seat, and a supporting bar; on the single cut base plate is provided the second sliding table cylinder and on the sliding table of the second sliding table cylinder is vertically provided a supporting bar; the scissors lifting seat is sleeved on the supporting bar and on the scissors lifting seat is provided a pneumatic scissors engaging with the work piece; on the scissors lifting seat is provided the pneumatic collet which vertically aligns with the pneumatic scissors; on the upper end of the supporting bar is provided a transverse plate and on the transverse plate, the adjusting handle which connects to the scissors lifting seat is threaded fitted; and all of the second sliding table cylinder, the pneumatic scissors and the pneumatic collet are electrically connected to the power control box.

Furthermore, the wire twisting mechanism may include a wire twisting servo motor, a holding board, a wire twisting claw, a rotatable seat, a photoelectric sensor, a bearing block, a rotation shaft and a synchronous belts; on the holding board is vertically provided the wire twisting servo motor whose output shaft fits the rotation shaft by the synchronous belts; the rotation shaft is vertically provided on the holding board with the bearing block and the upper end of the rotation shaft is connected to the rotatable seat; on the rotatable seat is vertically provided the wire twisting clamping claw which engages with the work piece and on the edge of the rotatable seat is provided a shading sheet; the shading sheet cooperates with the photoelectric sensor provided on the holding board and all of the wire twisting servo motor, the photoelectric sensor and the wire twisting clamping claw are electrically connected to the power control box.

Furthermore, the wire twisting and securing mechanism may include a vertical securing plate, a securing head, a securing lifting cylinder and a upper transverse securing plate; on the vertical securing plate is vertically provided the securing lifting cylinder; the output end of the securing lifting cylinder is connected to the upper transverse securing plate which slidably cooperates with the vertical securing plate; on the upper transverse securing plate is provided a securing head which engages with the work piece and the securing lifting cylinder is electrically connected to the power control box.

The beneficial effects of the present invention are shown as follows:

The present device may work with the motor production equipment to form an automated assembly line, which may include a turntable mechanism, a line collating part, a line cutting part and a wire twisting part with sophisticate design and high degree of automation. The device may save the time and human labor cost compared with the prior art, which may improve the production efficiency of the motor production assembly line.

With the design of the turntable mechanism and the disk continuous wire feeding can be promised. The central clamp and the positioning block can achieve accurate positioning and ensure the stability of the work piece on the clamping plate. And the wire separation claw may separate the intertwining lead wire.

With the design of wire collating mechanism, the first sliding table cylinder may drive the pneumatic claw to slide up and down and the wire combing claw may separate the intertwining lead wire to prevent knotting of motor lead wire. At the same time the positioning hole on the rotation base may cooperate with the positioning pin roll, to adjust wire combing angle to achieve smooth wire collating process.

With the design of wide cutting mechanism, the double-end cylinder may close the left cutting plate and the right plate and gather the upper blade and the lower blade to cut the redundant parts of the lead wire off. At the same time the holding plate may hold the lead wire in place which shows the sophisticated design.

With the design of the wire teasing mechanism, the wire teasing pin push cylinder may drive the wire teasing pin to separate the motor lead wire to prevent knotting of motor lead-out wire.

With the design of the single cutting mechanism, the pneumatic collet may clamp the lead wire, at the same time; the pneumatic scissors may trim the single lead wire.

With the design of the wire twisting mechanism, the wire twisting clamping claw may hold the lead wire in place, while the wire twisting servo motor may drive the rotation shaft. And the photoelectric sensor may be used to control the turning angle of the rotation shaft, which may facilitate to finish the wire twisting process.

With the design of wire twisting and securing mechanism, the securing lifting cylinder may press the securing head downward to finish securing process to prevent vibration of the work piece during the wire twisting process.

### BRIEF DESCRIPTION OF DRAWINGS

FIG. 1 shows the schematic structural diagram of the automatic motor lead wire cutting and twisting assembly;

FIG. 2 shows the schematic structural diagram of the turntable mechanism;

FIG. 3 shows the enlarged view of A in FIG. 2;

FIG. 4 shows the schematic structural diagram of wire collating mechanism;

FIG. 5 shows the schematic structural diagram of wire teasing mechanism;

FIG. 6 shows a sectional structural view of the wide cutting mechanism;

FIG. 7 shows the schematic structural diagram of the wire twisting and securing mechanism;

FIG. 8 shows the schematic structural diagram of single cutting mechanism; and

FIG. 9 shows the schematic structural diagram of the wire twisting mechanism.

### DETAILED DESCRIPTION OF THE ILLUSTRATED EMBODIMENT

All of the various elements in the figures are shown as follows:
1. power control box,
2. rack,
3. wire twisting mechanism,
4. wire twisting and securing mechanism,
5. turntable mechanism,
6. wire collating mechanism,
7. wire teasing mechanism,
8, wide cutting mechanism,
9. single cutting mechanism,
10. reject tank,
11. servo drive motor,
12. gear box,
13. component,
14. disk,
15. clamping plate,
16. positioning block,
17. central clamp,
18. wire separation claw,
19. spring block,
20. positioning pin roll,
21. positioning hole,
22. rotation base,
23. wire collating base plate,
24. adjusting board,
25. pneumatic claw,
26. wire combing claw,
27. first sliding table cylinder,
28. vertical securing plate,
29. securing head,
30. securing lifting cylinder,
31. upper transverse securing plates,
32. wire teasing rack,
33. wire teasing pin,
34. wire teasing pin push cylinder,
35. wire teasing pin translational cylinder,
36. wire teasing lifting seat,
37. wire teasing lifting cylinder,
38. upper connecting plate,
39. left cutting plate,
40. upper blade,
41. holding plate,
42. reject trough,
43. lower blade,
44. right cutting plate,
45. wide cut base plate,
46. double-end cylinder,
47. top plate,
48. single cut base plate,
49. second sliding table cylinder,
50. pneumatic scissors,
51. pneumatic collet,
52. adjusting handle,
53. scissors lifting seat,
54. supporting bar,
55. wire twisting servo motor,
56. holding board,
57. wire twisting clamping claw,
58. rotatable seat,
59. photoelectric sensor,
60. bearing block,
61. rotation shaft,
62. synchronous belt.

In order to enable a person skilled in the art to better understand the technical scheme of the present invention, the following description may be given to the present invention in detail with reference to the accompanying drawings. The description of the invention is merely exemplary and explanatory and should not limit the scope of the protection scope of the present invention.

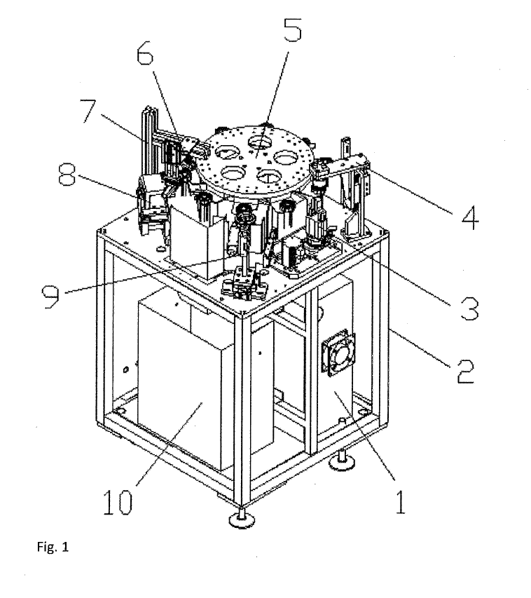

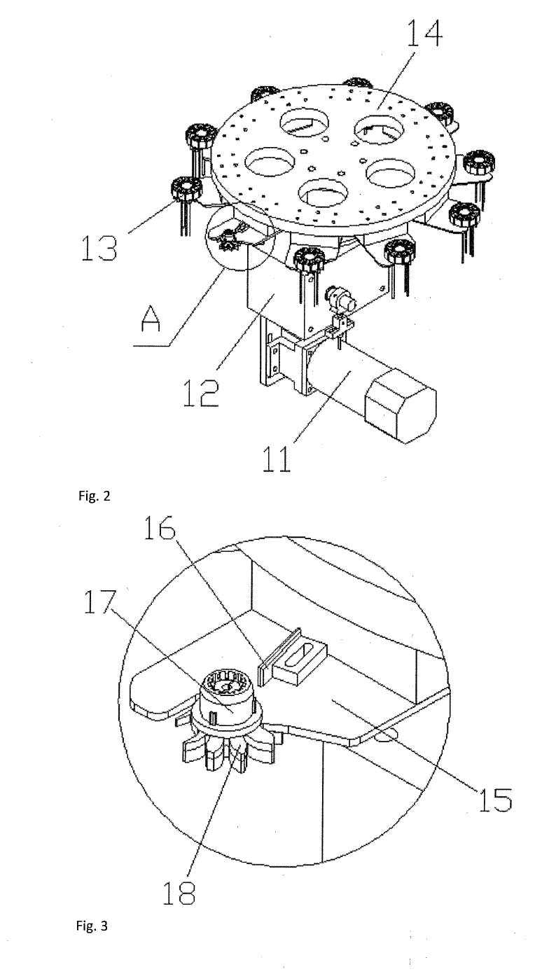

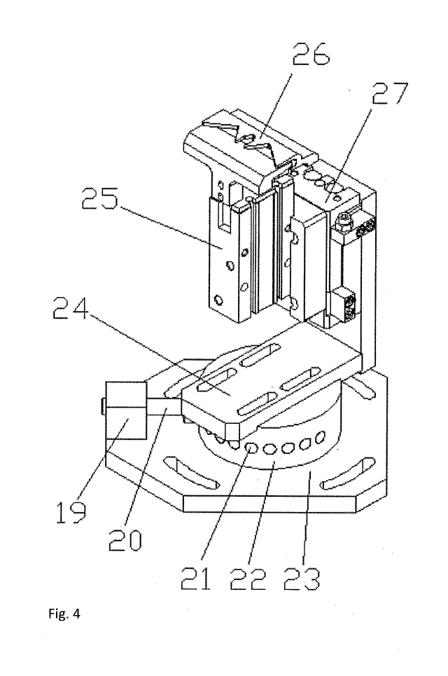

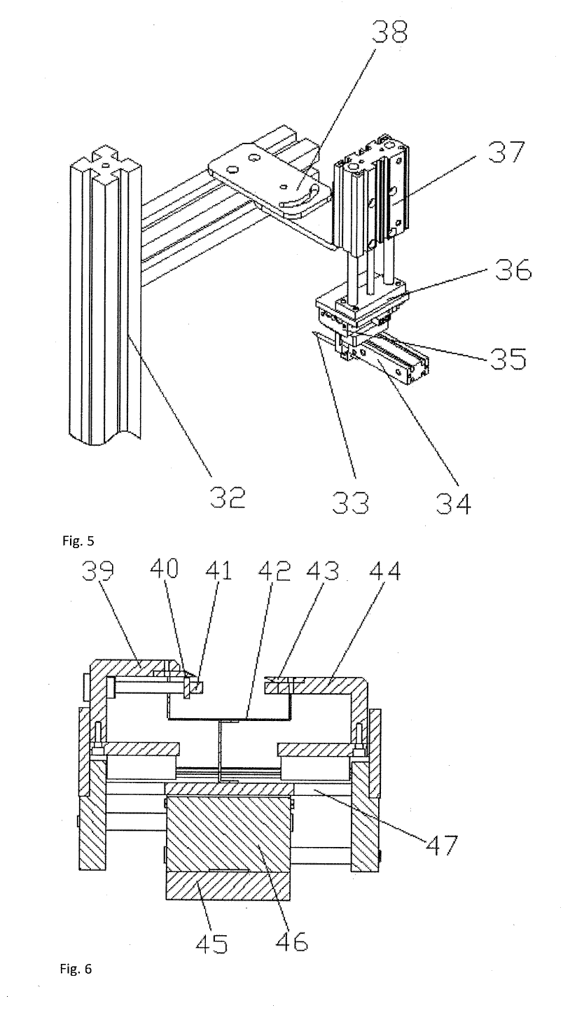

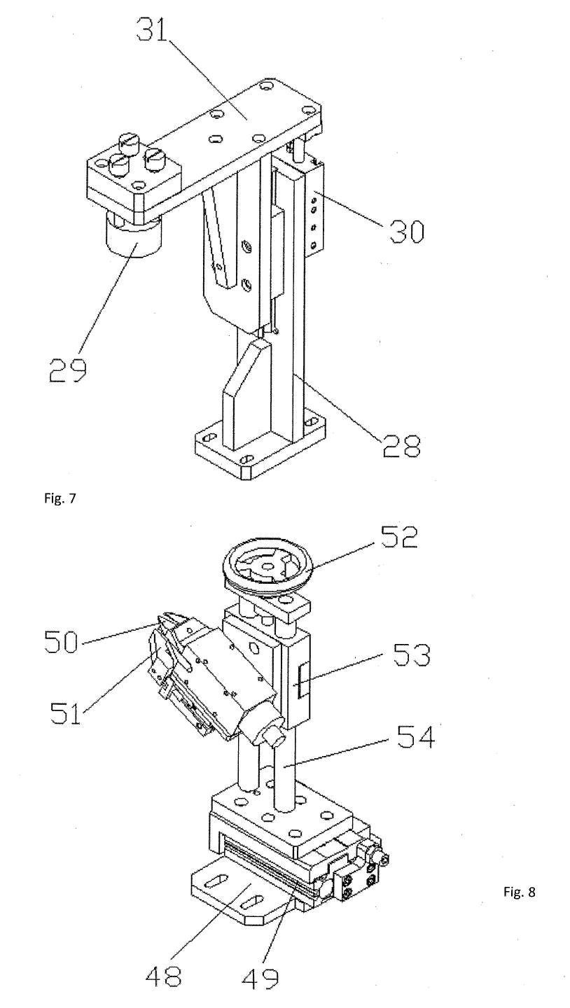

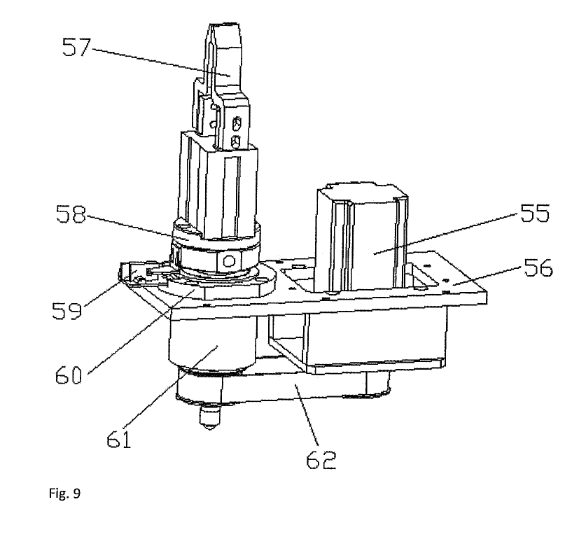

As it shown in FIG. 1-FIG. 9, the present invention is shown as follows: an automatic motor lead wire cutting and twisting assembly, which comprises a rack 2, a turntable mechanism 5 and a power control box 1 which are both provided on the rack 2; a wire collating mechanism 6, a wire teasing mechanism 7, a wide cutting mechanism 8, a single cutting mechanism 9 and a wire twisting mechanism 3 are in turn provided on the rack 2 around the turntable mechanism 5; a wire twisting and securing mechanism 4 is provided on the rack 2 above the wire twisting mechanism 3; a reject tank 10 is provided on the rack 2 below the wide cutting mechanism 8 and the single cutting mechanism 9; all of the drive components of the above mechanisms are electrically connected to the power control box 1.

Preferably, the turntable mechanism 5 comprises a servo drive motor 11, a gear box 12, a disk 14, clamping plates 15, a positioning block 16, a central clamp 17 and a wire separation claw 18; the output shaft of the servo drive motor 11 engages with the input shaft of the gear box 12 by a synchronous pulley; the upper end of the output shaft of the gear box 12 is connected to the center of the disk 14; to the outer edge of the disk 14 are evening distributed several clamping plate 15; the central clamp 17 which holds the work piece 13 is provided on the clamping plates 15; a wire separation claw 18 which engages with lead wires of the work piece 13 is provided on the lower part of the central clamp 17; a positioning block 16 cooperating with the work piece 13 is provided on the clamping plates 15; and the servo drive motor 11 is electrically connected to the power control box 1.

Preferably, the wire collating mechanism 6 may include a spring block 19, a positioning pin roll 20, a rotation base 22, a wire collating base plate 23, an adjusting board 24, a pneumatic claw 25, a wire combing claw 26, and a first sliding table cylinder 27; on the wire collating base plate 23 is provided the rotation base 22 and on the rotation base 22 is provided the adjusting board 24; on the adjusting board 24 is vertically provided the first sliding table cylinder 27 and on the first sliding table cylinder 27 is vertically provided the pneumatic claw 25; on the upper end of the pneumatic claw 25 is vertically provided the wire combing claw 26 engaging with the work piece 13; on the wire collating base plate 23 are provided the spring block 19 and the positioning pin roll 20 which engage with each other; the positioning pin roll 20 engages with the positioning hole 21 provided on the side of the rotation base 22 by plugging and fitting; and both the first sliding table cylinder 27 and the pneumatic claw 25 are electrically connected to the power control box 1.

Preferably, the wide cutting mechanism 8 may include the left cutting plate 39, the upper blade 40, a holding plate 41, a reject trough 42, the lower blade 43, the right cutting plate 44, a wide cut base plate 45, a double-end cylinder 46, a top plate 47. On the wide cut base plate 45 is provided the double-end cylinder 46 whose both sides are respectively connected to the left cutting plate 39 and the right cutting plate 44 which engage with each other. The left cutting plate 39 and the right cutting plate 44 are both slidingly fit the top plate 47 which is provided on the wide cut base plate 45. The upper blade 40 is provided on the right end of the left cutting plate 39 and the lower blade 43 fit the upper blade 40 is provided on the left end of the right cutting plate 44. The holding plate 41 is in butting and matching with the right cutting plate 44 provided on the left cutting plate 39. Above the top plate 47 and below the holding plate 41 is provided the reject trough 42. The double-end cylinder 46 is connected to the power control box 1.

Preferably, the wire teasing mechanism 7 may include a wire teasing rack 32, a wire teasing pin 33, a wire teasing pin pushing cylinder 34, a wire teasing pin translation cylinder 35, a wire teasing lifting seat 36, a wire teasing lifting cylinder 37, and an upper connecting plate 38; the wire teasing lifting cylinder 37 is vertically provided on the wire teasing rack 32 by the upper connecting plate 38 and the output end of the wire teasing lifting cylinder 37 is connected to the wire teasing lifting seat 36; the bottom of the wire teasing lifting seat 36 is connected to the wire teasing pin translational cylinder 35, whose output end is connected to the wire teasing pin push cylinder 34; the output end of the wire teasing pin push cylinder 34 is connected to the wire teasing pin 33 engaging with the work piece 13 and all the wire teasing lifting cylinder 37, the wire teasing pin translational cylinder 35 and the wire teasing pin push cylinder 34 are electrically connected to the power control box 1.

Preferably, the single cutting mechanism 9 may include a single cut base plate 48, a second sliding table cylinder 49, a pneumatic scissors 50, a pneumatic collet 51, an adjusting handle 52, a scissors lifting seat 53, and a supporting bar 54; on the single cut base plate 48 is provided the second sliding table cylinder 49 and on the sliding table of the second sliding table cylinder 49 is vertically provided a supporting bar 54; the scissors lifting seat 53 is sleeved on the supporting bar 54 and on the scissors lifting seat 53 is provided a pneumatic scissors 50 engaging with the work piece 13; on the scissors lifting seat 53 is provided the pneumatic collet 51 which vertically aligns with the pneumatic scissors 50; on the upper end of the supporting bar 54 is provided a transverse plate and on the transverse plate, the adjusting handle 52 which connects to the scissors lifting seat 53 is threaded fitted; and all of the second sliding table cylinder 49, the pneumatic scissors 50 and the pneumatic collet 51 are electrically connected to the power control box 1.

Preferably, the wire twisting mechanism 3 may include a wire twisting servo motor 55, a holding board 56, a wire twisting claw 57, a rotatable seat 58, a photoelectric sensor 59, a bearing block 60, a rotation shaft 61 and a synchronous belts 62; on the holding board 56 is vertically provided the wire twisting servo motor 55 whose output shaft fits the rotation shaft 61 by the synchronous belts 62; the rotation shaft 61 is vertically provided on the holding board 56 with the bearing block 60 and the upper end of the rotation shaft 61 is connected to the rotatable seat 58; on the rotatable seat 58 is vertically provided the wire twisting clamping claw 57 which engages with the work piece 13 and on the edge of the rotatable seat 58 is provided a shading sheet; the shading sheet cooperates with the photoelectric sensor 59 provided on the holding board 56 and all of the wire twisting servo motor 55, the photoelectric sensor 59 and the wire twisting clamping claw 57 are electrically connected to the power control box 1.

Preferably, the wire twisting and securing mechanism 4 may include a vertical securing plate 28, a securing head 29, a securing lifting cylinder 30 and a upper transverse securing plate 31; on the vertical securing plate 28 is vertically provided the securing lifting cylinder 30; the output end of the securing lifting cylinder 30 is connected to the upper transverse securing plate 31 which slidably cooperates with the vertical securing plate 28; on the upper transverse securing plate 31 is provided a securing head 29 which engages with the work piece 13 and the securing lifting cylinder 30 is electrically connected to the power control box 1.

During use, first set up the control program of the assembly, turn on the power control and put the product on the clamping plate 15 in the turntable mechanism 5 by the loading manipulator. The positioning block 16 works with the central clamp 17 to locate the work piece 13 and the motor lead wire may be separated by the wire separation claw 18. Then the disk 14 may turn to move the work piece 13 to the top of the wire collating mechanism 6. The pneumatic claw 25 may control the wire combing claw 26 to make the motor lead line to be stuck in the corresponding trough on the wire combing claw 26. Then the first sliding table cylinder 27 may push the pneumatic claw 25 to move up and down to complete wire collating process, at the same time, the positioning hole 21 on the rotation base 22 cooperates with the positioning pin roll 20 to adjust the line combing angle. The disk 14 may turn again after wire collating, to drive the work piece 13 to be above the wide cutting mechanism 8. Then the wire teasing lifting cylinder 37 of the wire teasing mechanism 7 may push the wire teasing lifting seat 36 up and down, at the same time the wire teasing pin translation cylinder 35 moves horizontally left and right and the wire teasing pin push cylinder 34 may push the wire teasing pin 33 to tease the wires. And the double-end cylinder 46 of the wide cutting mechanism 8 may drive the upper blade 40 and the lower blade to cut the wires. When the upper and lower blade shut together, the holding plate 41 may cooperate with the right cutting plate 44 to hold the motor lead wire. And the rejected lead wires may be dropped into the reject trough 42 after cutting. The disk 14 may turn again when the first cutting process is done and drive the work piece to be above the single cutting mechanism 9. Turn the adjusting handle 52 in accordance with the desired product specifications. The length of the lead wire may be controlled by the height of the blade of the pneumatic scissors 50. And the feed operation of the second sliding table cylinder 49 may make the pneumatic collet 51 to clamp the single motor lead wire, and the pneumatic scissors 50 may start to cut the wires. After completing the second cutting, the disk 14 may turn to move the work piece above the wire twisting mechanism 3, then the wire twisting clamping claw 57 may clamp the lead wire, while the securing lifting cylinder 30 of the wire twisting and securing mechanism 4 may move downwards and press the upper transverse securing plates 31 to make the securing head 29 to press against the upper end of the work piece. Then the wire twisting servo motor 55 may drive the rotation shaft 61 to rotate by the synchronous belts 62 and control the rotation angle with the photoelectric sensor 59 cooperating with the shading sheet. Thereby the automated wire twisting process is achieved, structural design of the present invention is sophisticated, and convenient, and time and labor is greatly saved with the present invention, in the meantime production efficiency is improved.

It should be noted that the term “include” is used herein, “including” or any other variants thereof intended to encompass a non-exclusive inclusion, such that a process comprising a series of elements is included, the method, the article or the device not only comprise those elements but also include other elements not explicitly listed, or further includes the inherent elements of the process, the method, the article or the equipment.

The principle and the implementation mode of the invention are set forth in the specification. The description of the above examples is only used for helping understand the method of the invention and the core idea of the method. The above descriptions are only preferred embodiments of the present invention and it should be noted that due to the limitation of character expression, an infinite specific structure exists objectively. For persons of ordinary skill in the art, without departing from the principle of the present invention, a plurality of improvements, modifications and changes can be made. The technical features can also be combined in a proper manner. The conception and the technical scheme of the invention can be directly applied to other occasions without improving the conception and the technical scheme of the invention, which can be regarded as the protection scope of the invention.

What is claimed is:

1. An automatic motor lead wire cutting and twisting assembly, which comprises a rack (2), a turntable mechanism (5) and a power control box (1) which are both provided on the rack (2); a wire collating mechanism (6), a wire teasing mechanism (7), a wide cutting mechanism (8), a single cutting mechanism (9) and a wire twisting mechanism (3) are in turn provided on the rack (2) around the turntable mechanism (5); a wire twisting and securing mechanism (4) is provided on the rack (2) above the wire twisting mechanism (3); a reject tank (10) is provided on the rack (2) below the wide cutting mechanism (8) and the single cutting mechanism (9); all of the drive components of the above mechanisms are electrically connected to the power control box (1).

2. The automatic motor lead wire cutting and twisting assembly of claim 1, wherein the turntable mechanism (5) comprises a servo drive motor (11), a gear box (12), a disk (14), clamping plates (15), a positioning block (16), a central clamp (17) and a wire separation claw (18); the output shaft of the servo drive motor (11) engages with the input shaft of the gear box (12) by a synchronous pulley; the upper end of the output shaft of the gear box (12) is connected to the center of the disk (14); to the outer edge of the disk (14) are evening distributed several clamping plate (15); the central clamp (17) which holds the work piece (13) is provided on the clamping plates (15); a wire separation claw (18) which engages with lead wires of the work piece (13) is provided on the lower part of the central clamp (17); a positioning block (16) cooperating with the work piece (13) is provided on the clamping plates (15); and the servo drive motor (11) is electrically connected to the power control box (1).

3. The automatic motor lead wire cutting and twisting assembly of claim 2, wherein the wire collating mechanism (6) may include a spring block (19), a positioning pin roll (20), a rotation base (22), a wire collating base plate (23), an adjusting board (24), a pneumatic claw (25), a wire combing claw (26), and a first sliding table cylinder (27); on the wire collating base plate (23) is provided the rotation base (22) and on the rotation base (22) is provided the adjusting board (24); on the adjusting board (24) is vertically provided the first sliding table cylinder (27) and on the first sliding table cylinder (27) is vertically provided the pneumatic claw (25); on the upper end of the pneumatic claw (25) is vertically provided the wire combing claw (26) engaging with the work piece (13); on the wire collating base plate (23) are provided the spring block (19) and the positioning pin roll (20) which engage with each other; the positioning pin roll (20) engages with the positioning hole (21) provided on the side of the rotation base (22) by plugging and fitting; and both the first sliding table cylinder (27) and the pneumatic claw (25) are electrically connected to the power control box (1).

4. The automatic motor lead wire cutting and twisting assembly of claim 3, wherein the wide cutting mechanism (8) may include a left cutting plate (39), an upper blade (40), a holding plate (41), a reject trough (42), a lower blade (43), a right cutting plate (44), a wide cut base plate (45), a double-end cylinder (46), and a top plate (47); on the wide cut base plate (45) is provided the double-end cylinder (46) whose both ends are respectively connected to the left cutting plate (39) and the right cutting plate (44) which engage with each other; both the left cutting plate (39) and the right cutting plate (44) engage slidably with the top plate (47) which is provided on the wide cut base plate (45); an upper blade (40) is provided on the right end of the left cutting plate (39) and an lower blade (43) which cooperates with the upper blade (40) is provided on the left end of the right cutting plate (44); an holding plate (41) which joins and cooperates with the right cutting plate (44) is provided on the left cutting plate (39); above the top plate (47) below the holding plate (41) is provided the reject trough (42) and the double-end cylinder (46) is electrically connected to the power control box (1).

5. The automatic motor lead wire cutting and twisting assembly of claim 4, wherein the wire teasing mechanism (7) may include a wire teasing rack (32), a wire teasing pin (33), a wire teasing pin pushing cylinder (34), a wire teasing pin translation cylinder (35), a wire teasing lifting seat (36), a wire teasing lifting cylinder (37), and an upper connecting plate (38); the wire teasing lifting cylinder (37) is vertically provided on the wire teasing rack (32) by the upper connecting plate (38) and the output end of the wire teasing lifting cylinder (37) is connected to the wire teasing lifting seat (36); the bottom of the wire teasing lifting seat (36) is connected to the wire teasing pin translational cylinder (35), whose output end is connected to the wire teasing pin push cylinder (34); the output end of the wire teasing pin push cylinder (34) is connected to the wire teasing pin (33) engaging with the work piece (13) and all the wire teasing lifting cylinder (37), the wire teasing pin translational cylinder (35) and the wire teasing pin push cylinder (34) are electrically connected to the power control box (1).

6. The automatic motor lead wire cutting and twisting assembly of claim 5, wherein the single cutting mechanism (9) may include a single cut base plate (48), a second sliding table cylinder (49), a pneumatic scissors (50), a pneumatic collet (51), an adjusting handle (52), a scissors lifting seat (53), and a supporting bar (54); on the single cut base plate (48) is provided the second sliding table cylinder (49) and on the sliding table of the second sliding table cylinder (49) is vertically provided a supporting bar (54); the scissors lifting seat (53) is sleeved on the supporting bar (54) and on the scissors lifting seat (53) is provided a pneumatic scissors (50) engaging with the work piece (13); on the scissors lifting seat (53) is provided the pneumatic collet (51) which vertically aligns with the pneumatic scissors (50); on the upper end of the supporting bar (54) is provided a transverse plate and on the transverse plate, the adjusting handle (52) which connects to the scissors lifting seat (53) is threaded fitted; and all of the second sliding table cylinder (49), the pneumatic scissors (50) and the pneumatic collet (51) are electrically connected to the power control box (1).

7. The automatic motor lead wire cutting and twisting assembly of claim 6, wherein the wire twisting mechanism (3) may include a wire twisting servo motor (55), a holding board (56), a wire twisting claw (57), a rotatable seat (58), a photoelectric sensor (59), a bearing block (60), a rotation shaft (61) and a synchronous belts (62); on the holding board (56) is vertically provided the wire twisting servo motor (55) whose output shaft fits the rotation shaft (61) by the synchronous belts (62); the rotation shaft (61) is vertically provided on the holding board (56) with the bearing block (60) and the upper end of the rotation shaft (61) is connected to the rotatable seat (58); on the rotatable seat (58) is vertically provided the wire twisting clamping claw (57) which engages with the work piece (13) and on the edge of the rotatable seat (58) is provided a shading sheet; the shading sheet cooperates with the photoelectric sensor (59) provided on the holding board (56) and all of the wire twisting servo motor (55), the photoelectric sensor (59) and the wire twisting clamping claw (57) are electrically connected to the power control box (1).

8. The automatic motor lead wire cutting and twisting assembly of claim 7, wherein the wire twisting and securing mechanism (4) may include a vertical securing plate (28), a securing head (29), a securing lifting cylinder (30) and a upper transverse securing plate (31); on the vertical securing plate (28) is vertically provided the securing lifting cylinder (30); the output end of the securing lifting cylinder (30) is connected to the upper transverse securing plate (31) which slidably cooperates with the vertical securing plate (28); on the upper transverse securing plate (31) is provided a securing head (29) which engages with the work piece (13) and the securing lifting cylinder (30) is electrically connected to the power control box (1).
